(19) United States
(12) Patent Application Publication
(10) Pub. No.: US 2006/0230684 A1
(43) Pub. Date: Oct. 19, 2006

(54) Pocket door trolly assembly

(76) Inventor: Craig Poole, Santa Cruz, CA (US)

Correspondence Address: JEFFREY HALL, 212 CLINTON ST, SANTA CRUZ, CA, 95062, US

(21) Appl. No.: 11/105,069

(22) Filed: Apr. 13, 2005

(51) Int. Cl. E05D 15/06

(52) U.S. Cl. 49/409

(57) ABSTRACT

A pocket door trolley assembly for a pocket door system comprises a front and a rear trolley assembly each including a carrier unit and each having a plurality of rollers secured thereto. The front and the rear trolley assembly being configured to move within a track secured on a support surface. The front and rear trolley assemblies each have a scissor assembly secured to the carrier unit. A screw shaft assembly for adjustment and positioning of the pocket door is secured to the front trolley assembly and to the rear trolley assembly. The screw shaft assembly having two screw blocks secured thereto each screw block being connected to a hanger stud. One or more hanger plates are positioned on a top edge of the door hanger and have an aperture therein for receiving and securing a hanger stud therein.

### BACKGROUND OF THE INVENTION

1. Field of Invention

The present invention relates to an improved trolley assembly for a pocket door system, and in particular relates to a trolley assembly with new and improved door adjustment and door installation and removal features.

2. Description of Related Art

Pocket door systems are presently in widespread use in both residential and commercial applications. Generally, a pocket door system includes a header assembly having a track on which trolley assemblies are mounted for translational movement. A door is suspended from the trolley assemblies and is, therefore, capable of movement between a closed position and an open position wherein the door is concealed within a pocket formed in the surrounding wall structure. Such a door system offers the advantage over standard hinged door arrangements in that dedication of floor space is not required to open the door from a closed position.

A disadvantages with such pocket door track and trolley systems is with the door installed and the finish trim in place, there is no provision to adjust the height or alignment of the door with respect to the floor and side jams without removing some or all of the header trim to allow access to the adjuster. Also, removal of the door from the track and trolley assembly for painting, or replacement cannot be done without removal of all or part of the trim around the door opening.

Accordingly the primary object of the present invention is to provide a pocket door trolley system which allows for the installation and removal of doors without the removal of jam trim and allows for easy adjustment of doors after installation from the exposed end of door without the need to remove any of the trim from around the door opening.

Additional objects and advantages of the invention will be set forth in the description which follows, and in part will be obvious from the description, or may be learned by practice of the invention. The objects and advantages of the invention may be realized and obtained by means of the instrumentality's and combinations particularly pointed out in the appended claims.

### BRIEF SUMMERY OF INVENTION

A pocket door trolley assembly for a pocket door system is disclosed which allows for the installation and removal of doors without the removal of trim and allows for adjustment of the door after installation from the exposed end of the door without the need to remove any trim from around the door opening. Preferably, the pocket door trolley assembly for a pocket door system includes a front and a rear trolley assembly each including a carrier unit and scissor assembly, and each having a plurality of rollers secured thereto. The front and the rear trolley assembly being configured to move within a track secured on a support surface. A screw shaft assembly for adjustment and positioning of the pocket door is secured to the front trolley assembly and to the rear trolley assembly. The screw shaft assembly having two screw blocks secured thereto with each screw block being connected to a hanger stud. One or more hanger plates are positioned on a top edge of the door hanger and have an aperture therein for receiving and securing a hanger stud therein.

### BRIEF DESCRIPTION OF THE DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 is an elevation view of a typical pocket door system showing the door in a partially open position, according to the invention.

FIG. 2 is an assembly view of the track, trolley and door system, according to the invention.

FIG. 3 is a top view of the door showing the hanger clips installed, according to the invention.

FIG. 4 is an exploded perspective view of the trolley and hanger clip assembly of the invention, according to the invention.

FIG. 5 is a cross-sectional view taken along the lines 5-5 of FIG. 1, according to the invention.

FIG. 6 is a side view of a trolley and universal joint assembly, according to the invention.

FIG. 7 is a cross-sectional view taken along the lines 7-7 of FIG. 2, according to the invention.

### DETAILED DESCRIPTION OF THE INVENTION

Reference will now be made in detail to the present preferred embodiments of the invention as illustrated in the accompanying drawings.

In accordance with the present invention, there is provided a pocket door trolley assembly for a pocket door system including a front and a rear trolley assembly each including a carrier unit and each having a plurality of rollers secured thereto. The front and the rear trolley assembly being configured to move within a track secured on a support surface. A screw shaft assembly for adjustment and positioning of the pocket door is secured to the front trolley assembly and to the rear trolley assembly. The screw shaft assembly having two screw blocks secured thereto each screw block being connected to a hanger stud. One or more hanger plates are positioned on a top edge of the door and have an aperture therein for receiving and securing a hanger stud therein. The pocket door trolley assembly allows for quick and easy installation and removal of doors without the removal of jam trim and allows for easy adjustment of doors after installation from the exposed end of door without the need to remove any of the trim from around the door opening.

The present invention comprises a new and improved trolley assembly for a pocket door system comprising a front and rear trolley assembly including two central carriers having a plurality of rollers journaled for rotation thereon. Attached to the each carrier is an assembly comprised of a screw shaft with left hand screw threads at one end and right hand screw threads at the opposite end. Assembled onto the screw shaft are two screw blocks, one with left hand screw threads and the other with right hand screw threads. Attached to each side of the each screw blocks are two links. The upper end of each upper link on each side is attached to a common point of the carrier at each side of the carrier respectively. The lower end of each lower link on each side is attached to a common point at the hanger stud at each side respectively. Installed on the top edge of the door is a hanger clip with a hole through it, preferably in the shape of a key hole. Door material beneath the key hole is removed of a key hole. Door material beneath the key hole is removed to provide clearance for a hanger stud. Having positioned the door directly under the trolley assembly and hanger stud, the hanger stud is lowered into the large opening of the key hole in the hanger clip by turning the screw shaft in the direction that would cause the screw blocks to run towards each other and extend the hanger stud in the downward direction. Once the hanger stud is positioned into the hanger clip the trolley assembly is moved on the track translaterally in the direction that positions the hanger stud in the narrow part of the key hole. At this point turning the screw shaft in the opposite direction will elevate the door off of the floor, elevating it to the hanging position. With the door in the slightly open to fully open position the adjusters for the trolley assembly is easily accessed at the striker end of the door just above the top edge of the door. The front and rear trolley assemblies are identical in every respect with the following exception: Defining the trolley at the striker end of the door the front trolley, the rear trolley is different in that the adjuster screw is operated by a attached shaft having two universal joints in line with the shaft and a shaft section extending through a center bore of the screw shaft of the front trolley assembly. This enables the adjusters for each trolley to be accessible from the same location. This also allows for independent door height adjustment at each trolley assembly.

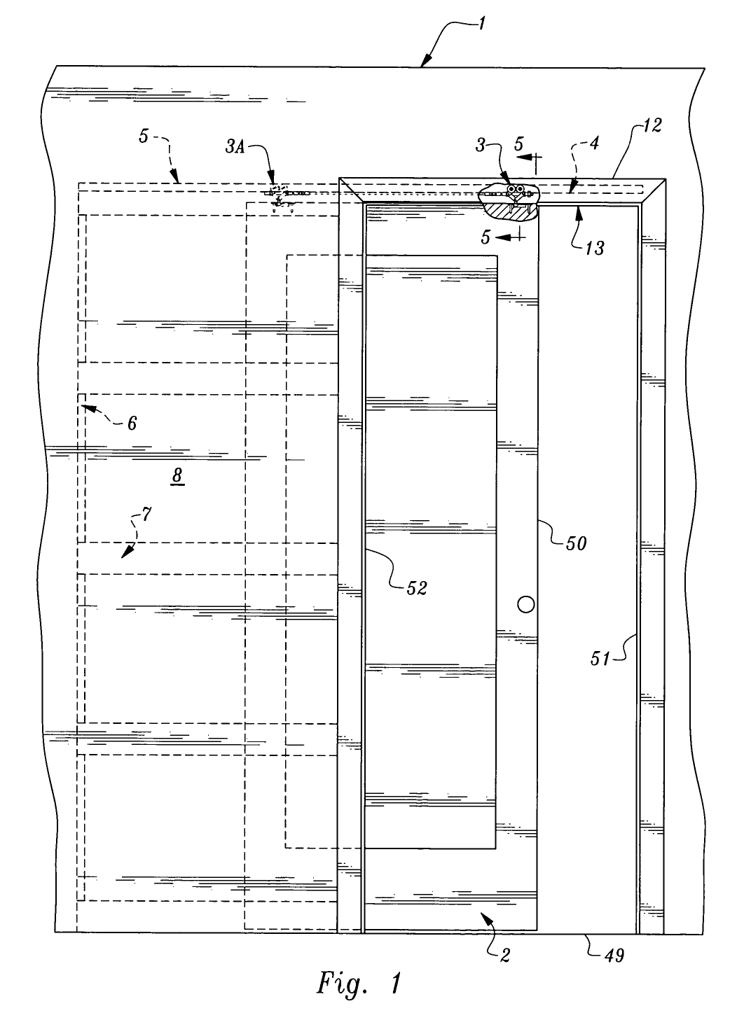

Referring now to the drawings, and initially to FIG. 1, a typical pocket door system designated by the reference numeral 1, is shown as comprising a door 2, moved to the partially open position and suspended on a pair of trolley assemblies, front trolley assembly 3, and rear trolley assembly 3A, each preferably including a carrier unit 14, and move in a track 4, attached to a support surface, such as header 5. The pocket door assembly is preferably installed in an opening generally designated by 6, which includes a plurality of slats 7, which together with a wall covering surface 8, form a pocket for receiving the door 2.

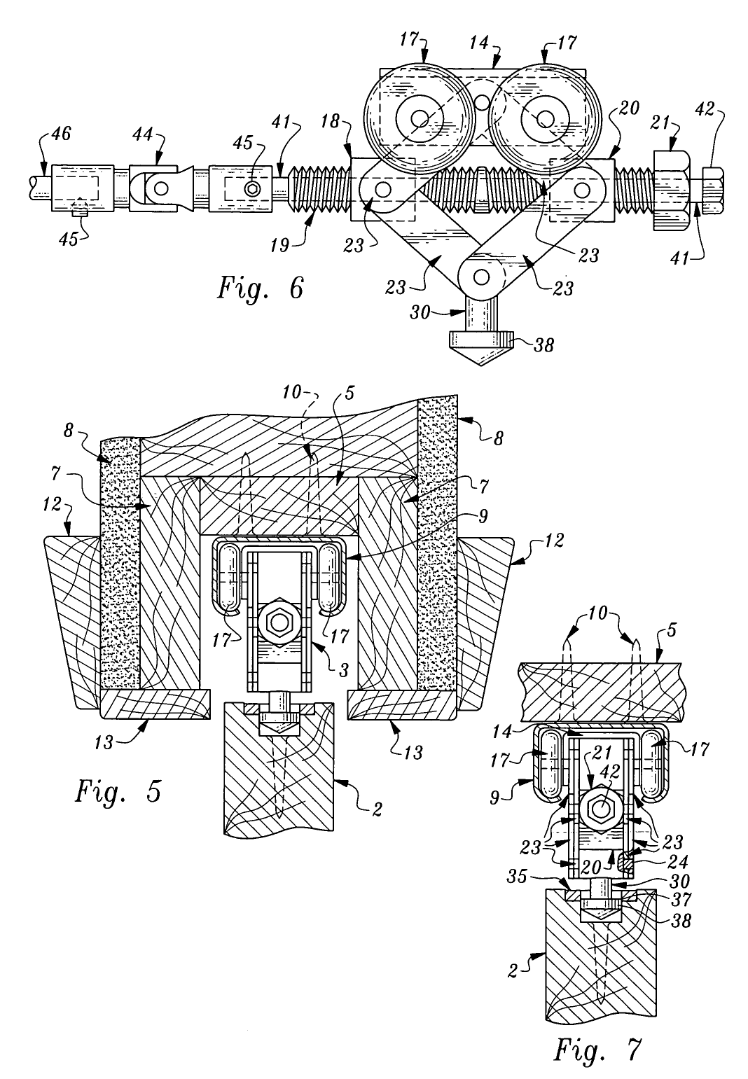

With reference to the cross-sectional view FIG. 5, the track 9, preferably formed from sheet metal or other durable resilient material, is configured to a dimension that allows for the free running of the wheels 17, and is preferably attached with a plurality of screws 10 to the header 5. Pocket frame slates 7, may be covered with a wall covering surface 8, over which a suitable trim 12, and stop 13, are preferably applied.

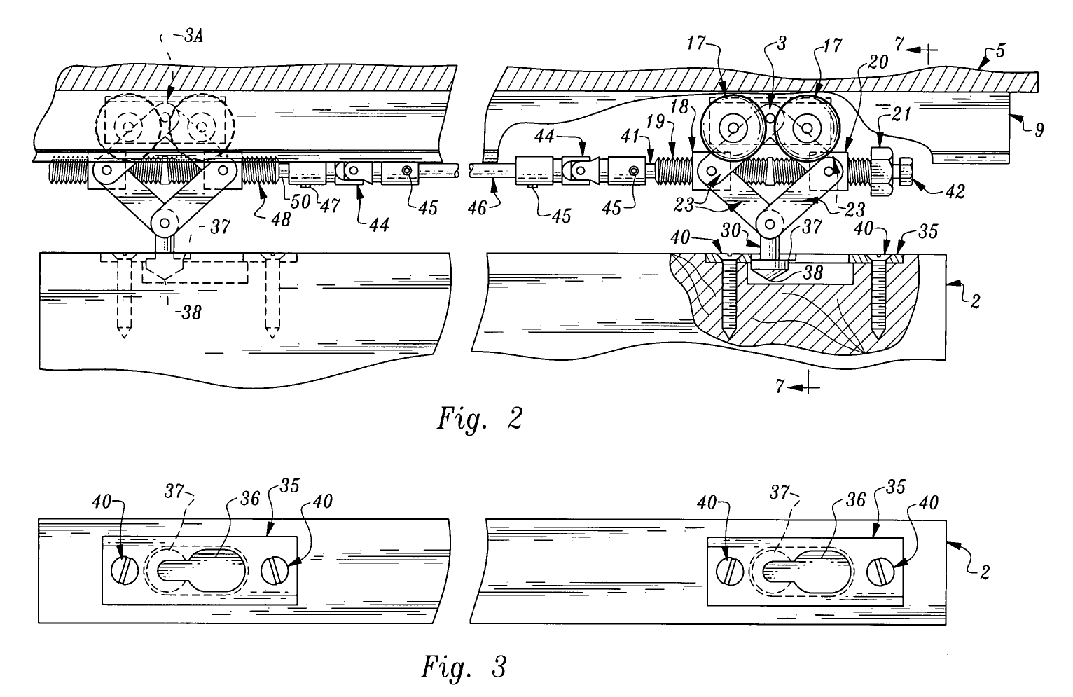

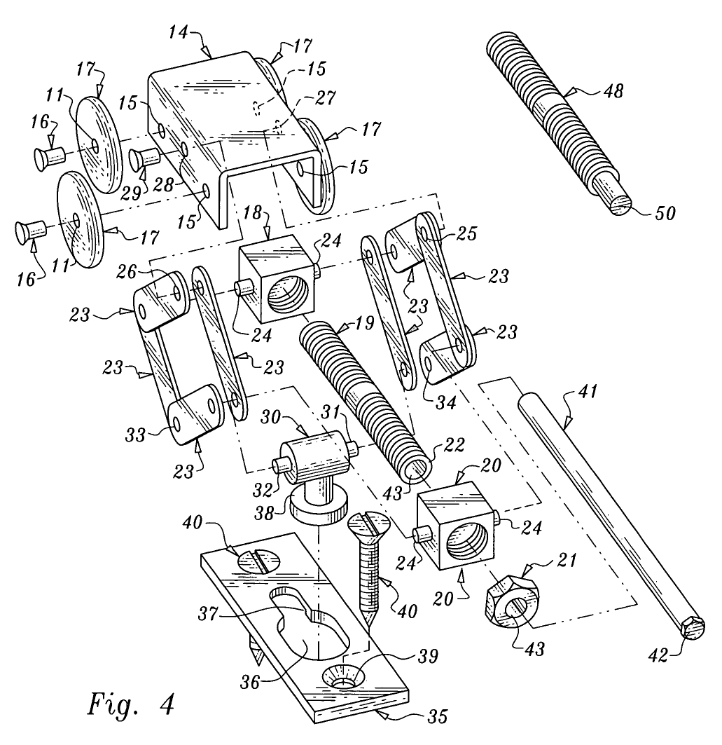

The component parts of the invention can best be seen in the exploded view of FIG. 4. These parts and their relation to each other can also be seen in FIGS. 2, 3, 6, and 7. Referring now to FIG. 4, the carrier unit 14, preferably has through holes 15, into which rivet 16, having passed through wheel 17, at hole 11, which is set into carrier unit 14, creating an axle around which wheels 17, can rotate. A screw assembly, including screw block 18, which preferably includes a center bore with left hand threads is installed on jack screw shaft 19, having left hand threads on one end to match block 18. Screw block 20 having a center bore with right hand threads is installed onto jack screw shaft 19, having right hand threads on one end to match block 20. Hex nut 21, preferably has a center bore to match the outside diameter of screw shaft 19, is preferably permanently installed on to the end 22, of jack screw shaft 19, using suitable means well known in the art for fixing said hex nut permanently. Scissor links 23, are preferably arranged in the manor shown and are installed to screw blocks 18, and 20, using the integral rivet studs 24. Hanger stud 30, having integral rivet studs 31, and 32, is preferably installed in concert with screw blocks 18, and 20, on to links 23, using holes 33, and 34, to match up with rivet studs 32, and 31, respectively. The installation of links 23, to rivet studs should be firm enough to secure the scissor links 23, yet loose enough to allow for rotational movement of the links. Scissor links 23, are secured to screw blocks 18, and 20, respectively, and hanger stud 30, which comprise a scissor assembly. The aforementioned scissor assembly is positioned on to carrier 14, using holes 25, and 26, respectively to match up with holes 27, and 28, on carrier 14, and securing assembly using rivet 29, on each side of carrier 14. Installation of links 23, with 29, should be firm enough to secure the scissor links 23, to carrier 14, yet loose enough to allow for rotational movement of the links.

Preferably, hanger plate 35, is a metal plate with a through hole 36, in the shape of a keyhole. However, hanger plate 35, may be constructed out of other durable resilient material. The under side of the narrow section of key hole 36, has a notch relief 37, for receiving hanger stud flange 38. Two holes 39, provide for the insertion of flathead screws 40, for securing of hanger plate 35, to top edge of door 2. To install hanger plate 35, into top edge of door 2, a recess mortis should be made in the shape and depth of hanger plate 35. Additionally, material at the location of the keyhole 37, should be removed to allow clearance for hanger stud flange 38. Hanger plate 35, having been installed flush too slightly recessed in top edge of door 2, may now be secured using screws 40.

In FIGS. 4 and 6, actuator shaft 41, preferably has an integral hex end 42, and is sized for a slip fit into bore 43. Actuator shaft 41, is inserted into bore 43, of hex nut 21, and jack screw shaft 19, where by universal joint assembly 44, is attached, securing using the set screw 45, best seen in FIGS. 2 and 6.

Referring now to FIG. 2, universal joints 44, are preferably coupled using coupler shaft 46, and secured using set screws 45. The coupler shaft assembly is preferably connected to jack screw shaft 48, at stub shaft 50, securing using set screw 47.

The two trolley assemblies 3 and 3A are similar except for one exception. In rear trolley assembly 3A, jack screw 48, preferably has an integral stub shaft 50, onto which a universal joint 44, is installed.

In operation and use, the pocket door trolley assembly of the present invention is very easy to install and use, and adjustments of the door(s) after installation is simple and very efficient.

Preferably, and as seen in FIGS. 1 and 2, the dimension height of door 2, is preferably sized to be slightly less than the dimension between the finish flooring 49, and the head stop 13. This allows for the easy insertion and removal of the door after the finish trim is in place. Preferably hanger plates 35, are installed into top edge of door 2 to be flush or slightly recessed into the top edge. Hanger plates 35, should be located on top edge of door 2, approximately as shown in FIG. 3, keeping in mind the accessibility of adjusters 21 and 42. Having installed the pocket frame shown in FIG. 3, keeping in mind the accessibility of adjusters 21 and 42. Having installed the pocket frame assembly 6, and the header 5, being level, the track 9, with it's two trolley assemblies installed and coupled using coupler shaft 46, is attached using screws 10, directly to the header 5.

Preferably, the length dimension of coupler shaft 46, is sized so that the center line dimension between the two trolley assemblies at hanger stud flange 38, matches the center line dimension between hanger plates 35. The hex nut 21, and hex end 42, may be rotated in the direction that elevates hanger stud flange 38, on both trolley assemblies to be slightly above top edge of door 2, while door 2 is standing in an upright position on the finish floor 49, slide door 2, into pocket opening and position it to be under the trolley assemblies so that hanger studs flange 38, is positioned directly over hanger plates 35, at keyholes 36. By turning hex nuts 21, and 42, this rotates jack screws 19, and 48, to lower hanger stud flanges 38, into keyholes 36, of hanger plates 35. The trolley assemblies are then rolled in the direction necessary to position hanger stud flanges 38, directly under hanger plates 35, at recesses 37. Hex nut 21, and 42, are then rotated to turn jack screws 19, and 48, in the direction required to elevate hanger stud flanges 38, into recesses 37, of hanger plates 35. Hanger stud flange 38, is elevated until door 2, is suspended above finish floor surface 49. Using hex nut 21, or 42, independently, edge 50, of door 2, can be adjusted to be parallel to jam 51, and stop 52.

As is evident from the above description, a wide variety of assemblies may be configured for may different applications which utilize the pocket door trolley system described herein and additional advantages and modifications will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept

What is claimed is:

1. A pocket door trolley assembly for a pocket door system which allows for the installation and removal of doors without the removal of trim and allows for adjustment of the door after installation from the exposed end of the door without the need to remove any of trim from around the door opening, comprising:
a front and a rear trolley assembly each including a carrier unit and each having a plurality of rollers operably secured thereto, said front and said rear trolley assembly being configured to operably move within a track secured on a support surface; said front and said rear trolley assembly each having a scissor assembly operably secured thereto;
a screw shaft assembly means for adjustment and positioning of said pocket door, said screw shaft assembly being operably secured to said front trolley assembly and to said rear trolley assembly; said screw shaft assembly having two screw blocks secured thereto; and
hanger stud means being secured to said front trolley assembly and to said rear trolley assembly for operable engagement to one or more hanger plates operably positioned on a top edge of the door; said hanger plates having an aperture therein for receiving and securing a hanger stud therein.

2. The pocket door trolley assembly of claim 1, wherein said rear trolley assembly includes an adjuster screw operated by an attached shaft having two universal joints in line with the shaft and a shaft section extending through a center bore of the screw shaft of said front trolley assembly.

3. The pocket door trolley assembly of claim 1, wherein said aperture in said one or more hanger plates is shaped like a keyhole for receiving and securing said hanger stud therein.

4. A pocket door trolley assembly for a pocket door system, comprising:
a front and a rear trolley assembly each having a plurality of rollers operably secured thereto, said front and said rear trolley assembly being configured to operably move within a track secured on a support surface;
a screw shaft assembly means for adjustment and positioning of said pocket door system is attached to the front trolley assembly and to the rear trolley assembly; said screw shaft assembly having two screw blocks secured thereto attached, each screw block being operably connected to a hanger stud; and
one or more hanger clips for installation on a top edge of the door; said hanger clip having an aperture therein for receiving and securing said hanger studs therein.

5. The pocket door trolley assembly of claim 4, wherein said rear trolley assembly includes an adjuster screw operated by an attached shaft having two universal joints in line with the shaft and a shaft section extending through a center bore of the screw shaft of said front trolley assembly.

6. The pocket door trolley assembly of claim 4, wherein said aperture in said one or more hanger plates is shaped like a keyhole for receiving and securing said hanger studs therein.

7. The pocket door trolley assembly of claim 4, wherein said front trolley assembly and said rear trolley assembly each have scissor links secured to said screw blocks and said hanger studs.

8. A trolley assembly for a door, comprising:
a front and a rear trolley assembly each having a plurality of rollers operably secured thereto, said front and said rear trolley assembly being configured to operably move in a track secured on a support surface; said front and said rear trolley assemblies each include a carrier unit secured thereto;
a screw shaft assembly including an actuator shaft is operably engaged to the front trolley assembly and to the rear trolley assembly; said screw shaft assembly having two screw blocks secured thereto, each screw block being operably connected to a hanger stud; and
one or more hanger clips for installation on a top edge of the door; said hanger clip having an aperture therein for receiving and securing said hanger studs therein.

9. The pocket door trolley assembly of claim 8, wherein said rear trolley assembly includes an adjuster screw operated by an attached shaft having two universal joints in line with the shaft and a shaft section extending through a center bore of the screw shaft of said front trolley assembly.

10. The pocket door trolley assembly of claim 8, wherein said aperture in said one or more hanger plates is shaped like a keyhole for receiving and securing said hanger studs therein.

11. The pocket door trolley assembly of claim 7, wherein said front trolley assembly and said rear trolley assembly each have scissor links secured to said screw block and said hanger studs.
